(19) United States
(12) Patent Application Publication
(10) Pub. No.: US 2008/0030084 A1
(43) Pub. Date: Feb. 7, 2008

(54) Cooling air flow passage for vehicular alternator

(75) Inventor: Takafumi Tsuge, Ena-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/882,529

(22) Filed: Aug. 2, 2007

(30) Foreign Application Priority Data
Aug. 4, 2006 (JP) 2006-213341

(51) Int. Cl. H02K 9/00

(52) U.S. Cl. 310/52

(57) ABSTRACT

In a cooling air flow passage for a vehicular alternator, a cooling air blows from a top toward a bottom of a cooling air room formed between a primary and secondary rear covers through a suction duct of an approximate character “L” shape. The cooling air is then supplied in diffusion into an electrical component room adjacently formed in front of the cooling air room. A sectional area of an inlet opening of the secondary rear cover is smaller than that of a suction opening of the suction duct in order to accelerate the flowing speed of the cooling air at the inlet opening, and to supply the accelerated cooling air into the cooling air room adjacent to the electrical component room in the axial direction. This can reduce a necessary width of the cooling air room in the axial direction of the alternator and efficiently cool each electrical component.

### CROSS-REFERENCE TO RELATED APPLICATION

This application is related to and claims priority from Japanese Patent Application No. 2006-213341 filed on Aug. 4, 2006, the contents of which are hereby incorporated by reference.

### BACKGROUND OF THE INVENTION

1. Field of the Invention

The present invention relates to a cooling air flow passage for a vehicular alternator, in particular, relates to an improved mechanism of the cooling air flow passage for the vehicular alternator.

2. Description of the Related Art

In usual vehicular alternators, electrical components such as a rectifier, a brush, and a regulator are disposed at the rear side of the vehicular alternator, namely, disposed at the opposite side of a pulley which is fixed to a rotary shaft of the vehicular alternator. Such an arrangement of the electrical components in the vehicle will be referred to as “an electrical-component rear side arrangement manner”.

In such an electrical-component rear side arrangement manner, a cooling air is generally introduced, namely, sucked into the inside of a rear frame or a resin cover through an inlet opening formed at a rear end surface of the rear frame in order to efficiently cool those electrical components such as a regulator and a rectifier which must be preferentially cooled. The regulator, as an electrical power generation controlling device, is composed of semiconductor chips. Hereinafter, such a cooling air flow suction manner is referred to as “a rear side cooling air suction manner”.

Japanese patent laid open publication No. JP H5-219685 has disclosed a mechanism of a cooling air flow passage (referred to as “a cover mechanism with a suction duct of a front opening character “L” shape) which is one of related-art techniques regarding the rear side cooling air suction manner. In the cover mechanism with a suction duct of a front opening character “L” shape, the suction duct of a character “L” shape extends toward a front side of the vehicular alternator (namely, toward a pulley side in the axial direction of the rotary shaft) from a circumferential wall part of the resin cover which covers the rear frame.

The suction duct of a character “L” shape has a mechanism of a cooling air flow passage of a schematic character “L” shape having a suction opening which is open toward the front side of a vehicle, extending toward the rear side in the axial direction of the rotary shaft, and bending toward the inside direction of the vehicular alternator in the radial direction thereof. The use of the cover mechanism with a suction duct of a front opening character “L” shape can provide the cooling air flow (heat-sealed cooling air flow), which is not heated by an engine and the like, to the rear side of the vehicular alternator. However, although such a mechanism of the cooling air flow passage for a vehicular alternator having the cover mechanism with a suction duct of a front opening character “L” shape disclosed in JP H5-219685 has a superior heat-sealing capability, it involves an intrinsic drawback to increase a fluid resistance of the cooling air flow in the cooling air flow passage when compared with that of the usual rear side suction manner which has not the suction duct of the front opening character “L” shape.

Such a related-art drawback described above becomes a serious problem when the vehicle falls in idling state because of hardly using a pressure generated by wind which is always generated during the moving of the vehicle. That is, because a cooling fan mounted on a rotor in the alternator has a poor cooling-air supplying capability during the idling state of the vehicle, the suction duct of a character “L”-shape increases the fluid loss, and the increasing of such a fluid loss further decreases the volume of the cooling air flowing through the cooling air flow passage for the vehicular alternator. In order to solve such a related-art drawback, the related-art technique JP H5-219685 has disclosed the use of an additional electrical fan which is mounted on the suction duct of a character “L” shape in order to have the necessary volume of the cooling air flow. However, the additional electrical fan increases the initial manufacturing cost, running cost, total size and weight of the vehicular alternator, and it is thereby difficult to mount such a suction duct of a character “L” shape on an ordinary-sized vehicle in view of recent strong demand of down-sizing and down-weighting in the field of vehicles.

### SUMMARY OF THE INVENTION

It is an object of the present invention to provide a cooling air flow passage with an improved mechanism for a vehicular alternator capable of efficiently cooling electrical components such as semiconductor elements while avoiding sucking the cooling air which flows from a rear side of a vehicular engine, and capable of preventing the increase of fluid loss in the cooling air flow passage and of securing a necessary volume of the cooling air flow for the vehicular alternator.

To achieve the above purposes, the present invention provides a cooling air flow passage for a vehicular alternator has a suction duct of a tube shape and a rear cover. The rear cover of a shallow plate shape accommodates a rear end surface of an alternator housing which accommodates electrical components in the vehicular alternator including at least a regulator and a rectifier. The rear cover is used as a part of a cooling air flow passage for a vehicular alternator. The rear cover has an inlet opening formed at a top of a circumferential wall thereof and introduces the cooling air supplied from the suction duct. That is, the cooling air flow is gathered and sucked into the inside of the rear cover (forming the cooling air flow passage) through the inlet opening of the rear cover (hereinafter, also referred to as “a cooling air blowing-in manner through a rear cover top part”).

The cooling air blowing-in manner through a rear cover top part can suck the cooling air of a lower temperature when compared with a related art manner in which a cooling air is sucked through an inlet opening formed at the end wall part of the rear cover in the axial direction of the vehicular alternator.

On the contrary, according to the present invention, because the inlet opening is formed at the top part (preferably, at an approximate top-end part) of the circumferential wall part of the rear cover, it is possible to prevent any invasion of muddy water flied from a road on which the vehicle travels. In particular, according to the mechanism of the cooling air flow passage of the present invention, the sectional area of the inlet opening of the rear cover is smaller than that of a suction opening of the suction duct. That is, the present invention has a feature that the inlet opening formed at the top part of the circumferential wall of the rear cover is smaller in sectional area than the suction opening of the suction duct in order to concentrate the cooling air flow supplied through the suction duct into the inside of the rear cover. The suction duct joins to the inlet opening of the rear cover. Through the suction duct, external cooling air is sucked in the cooling air flow passage. This configuration enables that the speed of the cooling air flow can increase at the joint part between the suction duct and the inlet opening of the rear cover. The cooling air flow whose speed id increased blows down into the inside of the rear cover as the cooling air flow passage. It is thereby possible to generate the cooling air flow of a high speed and to efficiently cool the electrical components by the cooling air flow. Still further, in the construction of the air cooling flow passage of the present invention, because the width of the rear cover at the joint part between the suction duct and the inlet opening of the rear cover is reduced in the axial direction of vehicular alternator, it is possible to further reduce the entire size of the vehicular alternator.

In the cooling air flow passage for the vehicular alternator as another aspect of the present invention, the rear cover has a partition wall (also referred to as “a connector wall part”) for a connector part surrounding external electrical terminals for the electrical components, and the partition wall for the connector part is vertically disposed from an end wall part of the rear cover toward the inside direction of the rear cover in an axial direction of the vehicular alternator along a side surface of the cooling air flow supplied from the inlet opening into the inside of the rear cover in an approximate radial direction of the vehicular alternator.

This configuration of the cooling air flow passage can efficiently supply the cooling air flow, which is blown into the inside of the rear cover from the top part of the circumferential wall of the rear cover, into the bottom half area of the rear cover while preventing the increase of the fluid loss. It is thereby possible to enhance the cooling capability of cooling the electrical components arranged at the lower half area of the rear cover.

In more detail explanation, the speed of the cooling air flow blown into the inside of the rear cover through the inlet opening which is formed at the top part of the circumferential wall of the rear cover becomes in general rapidly reduced according to going away from the inlet opening. This means that the speed of the cooling air flow is determined by dividing a volume of the cooling air flow by a sectional area of the cooling air flow passage when the fluid resistance of the cooling air flow passage is omitted. Still further, the reduction of the speed of the cooling air flow is further decreased when considering the fluid resistance.

For example, when the inlet opening is formed at the top part of the circumferential wall of the rear cover, the cooling air flow supplied through the inlet opening into the inside of the rear cover rapidly expands or diffused toward the right and left directions immediately following the inlet opening, and swirl is generated there. This phenomenon also generates a large amount of the fluid loss in the rear cover forming the cooling air flow passage. In order to solve such a drawback, the improved construction of the cooling air flow passage according to the present invention blows the cooling air flow supplied from the suction duct through the inlet opening of the rear cover toward the bottom side of the rear cover along the partition wall for the regulator and/or the partition wall of the connector part for the regulator. Because this construction of the cooling air flow passage can prevent the diffusion of the cooling air flow toward the right and left directions, it is possible to efficiently supply the cooling air flow toward the bottom part of the rear cover while decreasing the fluid loss.

In the cooling air flow passage for the vehicular alternator as another aspect of the present invention, the rear cover has a partition wall for the primary connector part including the output terminals and a partition wall for the secondary connector part forming the external connection terminals for the regulator. The partition walls of both the connectors are disposed at both sides of the passage of the cooling air flow blowing down toward the inside of the rear cover in the radial direction of the vehicular alternator through the inlet opening. It is thereby possible to suppress the generation of the fluid loss caused by diffusing the cooling air flow toward the right and left directions immediately after the cooling air flow blows down toward the inside of the rear cover through the inlet opening formed at the top part on the circumferential wall of the rear cover.

In the cooling air flow passage for the vehicular alternator as another aspect of the present invention, the end wall part of the rear cover is positioned at a side of the cooling air flow passage supplied from the inlet opening to the inside of the rear cover in the approximate radial direction of the vehicular alternator, and the end wall part of the rear cover has a concave shape toward the front side of the axial direction of the vehicular alternator when compared with the shape of a part other than the end wall part of the rear cover. This construction of the cooling air flow passage efficiently supplies the cooling air flow, blown down from the top part of the circumferential wall of the rear cover, to the inside of the rear cover, to the bottom half area of the rear cover while suppressing the increase of the fluid loss. It is thereby possible to increase the capability of cooling the electrical components (for the rectifier, for example) arranged in the bottom half area of the rear cover. In more detail explanation, in case of forming the inlet opening at a local part of the top part in the circumferential wall of the rear cover, because the cooling air flow blowing into the rear cover from the inlet opening expands in right and left directions immediately through the inlet opening, large fluid loss is caused by generating swirl there. In order to avoid increasing the fluid loss at the area immediately after the inlet opening of the rear cover, the cooling air flow passage according to the present invention has the partition walls of a concave shape at both the sides of the cooling air flow passage following the inlet opening. Because this configuration of the partition walls of a concave shape can prevent the diffusion of the cooling air flow, blowing down from the inlet opening into the inside of the rear cover toward both the right and left directions, immediately after the inlet opening, it is thereby possible to efficiently supply the cooling air flow to the bottom part of the rear cover while preventing the decreasing of the fluid loss.

In the cooling air flow passage for the vehicular alternator as another aspect of the present invention, the electrical components are disposed in front of the inlet opening of the rear cover in the axial direction of the vehicular alternator, and the inside end wall surface of the rear cover comprises a guide plate which projects toward the front side of the axial direction of the vehicular alternator capable of changing the cooling air flow supplied from the inlet opening to the inside direction of the rear cover along the radial direction of the vehicular alternator toward one of the front of the axial direction of the vehicular alternator and a predetermined direction in the radial direction of the vehicular alternator. It is thereby possible to efficiently supply the cooling air flow to the electrical components of specified electrical devices which require the cooling air flow which blows from the top part of the circumferential wall of the rear cover to the inside of the rear cover while preventing the increasing of the fluid loss. As described above, the improved construction of the cooling air flow passage of the present invention has a superior cooling capability for the electrical components.

In the cooling air flow passage for the vehicular alternator as another aspect of the present invention, the guide plate has a shape which curves from a part adjacent to the inlet opening to a part adjacent to the regulator at a lateral side of the rear cover.

In the cooling air flow passage for the vehicular alternator as another aspect of the present invention, the guide plate is positioned adjacent to the rectifying elements forming the rectifier and has a shape of changing the cooling air flow supplied through the inlet opening into the inside of the rear cover toward a front part in the axial direction of the vehicular alternator.

In the cooling air flow passage for the vehicular alternator as another aspect of the present invention, the suction duct has a character “L” shape which extends from the suction opening, through which external cooling air is introduced, toward the rear side in the approximate axial direction of the vehicular alternator, and curves to the inlet opening of the rear cover along the inside of the rear cover in the approximate radial direction of the vehicular alternator. Because this configuration of the suction duct in the cooling air flow passage can introduce the external cooling air from the front side of the vehicular alternator in the axial direction thereof, namely, from the pulley side of the vehicular alternator, it is possible to supply the cooling air flow which is hardly affected from the thermal energy of exhaust gas discharged from an internal combustion engine of the vehicle through an exhaust gas pipe.

In the cooling air flow passage for the vehicular alternator as another aspect of the present invention, the suction duct has a character “L” shape which extends from the suction opening, through which the external cooling air is sucked, toward an engine side along a direction of an approximately tangential line of the rear cover, and the suction duct curves to the inlet opening of the rear cover in the inside of the rear cover along the approximate radial direction of the vehicular alternator. Because the cooling air flow is hardly affected from the thermal energy of exhaust gas discharged form an internal combustion engine of the vehicle through an exhaust gas pipe, it is thereby possible to use the cooling air flow for cooling the electrical components disposed in the rear cover in the vehicular alternator mounted on the vehicular engine which is a transverse engine laterally disposed in an engine room of the vehicle.

In the cooling air flow passage for the vehicular alternator as another aspect of the present invention, the inlet opening has a shape capable of sucking the cooling air flow from the circumferential wall part of the rear cover into the inside of the rear cover along an approximately tangential direction of the rear cover, and the inner end surface of the rear cover has a guide wall by which the cooling air flow supplied through the inlet opening is spirally introduced into the inner radial direction of the vehicular alternator. This configuration can forcedly supply the cooling air flow into the inside of the rear cover while decreasing the fluid loss in the cooling air flow passage.

### BRIEF DESCRIPTION OF THE DRAWINGS

A preferred, non-limiting embodiment of the present invention will be described by way of example with reference to the accompanying drawings, in which:

FIG. 1 is a schematic cross sectional view of a vehicular alternator with a cooling air flow passage in an axial direction thereof according to a first embodiment of the present invention;

FIG. 2 is an elevation view of the cooling air flow passage for the vehicular alternator observed from a rear side of the vehicular alternator according to the first embodiment shown in FIG. 1;

FIG. 3 is a perspective view of a secondary rear cover and a suction duct in the cooling air passage for the vehicular alternator according to the first embodiment shown in FIG. 1;

FIG. 4 is a perspective view of the secondary rear cover observed from its front part toward its rear side in the axial direction of the vehicular alternator according to the first embodiment shown in FIG. 1;

FIG. 5 is a perspective view of the vehicular alternator the secondary rear cover observed from its front part toward its rear side in the axial direction of the vehicular alternator according to a third embodiment of the present invention;

FIG. 6 is a schematic cross sectional view of a rear cover and a suction duct in the cooling air flow passage for the vehicular alternator according to a fifth embodiment of the present invention;

FIG. 7 is an elevation view of a cooling air flow passage for the vehicular alternator according to the sixth embodiment observed from a rear side of the vehicular alternator;

FIG. 8 is a schematic elevation view of a second rear cover and a suction duct in the cooling air flow passage observed from its front part toward its rear side in the axial direction of the vehicular alternator, for the vehicular alternator according to a seventh embodiment;

FIG. 9 is an elevation view of the second rear cover and the suction duct in the cooling air flow passage for the vehicular alternator according to the seventh embodiment shown in FIG. 8;

FIG. 10 is a schematic elevation view of a second rear cover and a suction duct in the cooling air flow passage for the vehicular alternator observed from its front part toward its rear side, according to an eighth embodiment of the present invention;

FIG. 11 is an elevation view of the second rear cover and the suction duct in the cooling air flow passage for the vehicular alternator according to the eighth embodiment shown in FIG. 10; and

FIG. 12 is a perspective view of the second rear cover and the suction duct in the cooling air flow passage for the vehicular alternator according to a second embodiment of the present invention.

### DETAILED DESCRIPTION OF THE PREFERRED EMBODIMENTS

Hereinafter, various embodiments of an improved mechanism of a cooling air flow passage for a vehicular alternator according to the present invention will be described with reference to the accompanying drawings. In the following description of the various embodiments, like reference characters or numerals designate like or equivalent component parts throughout the several diagrams.

### First Embodiment

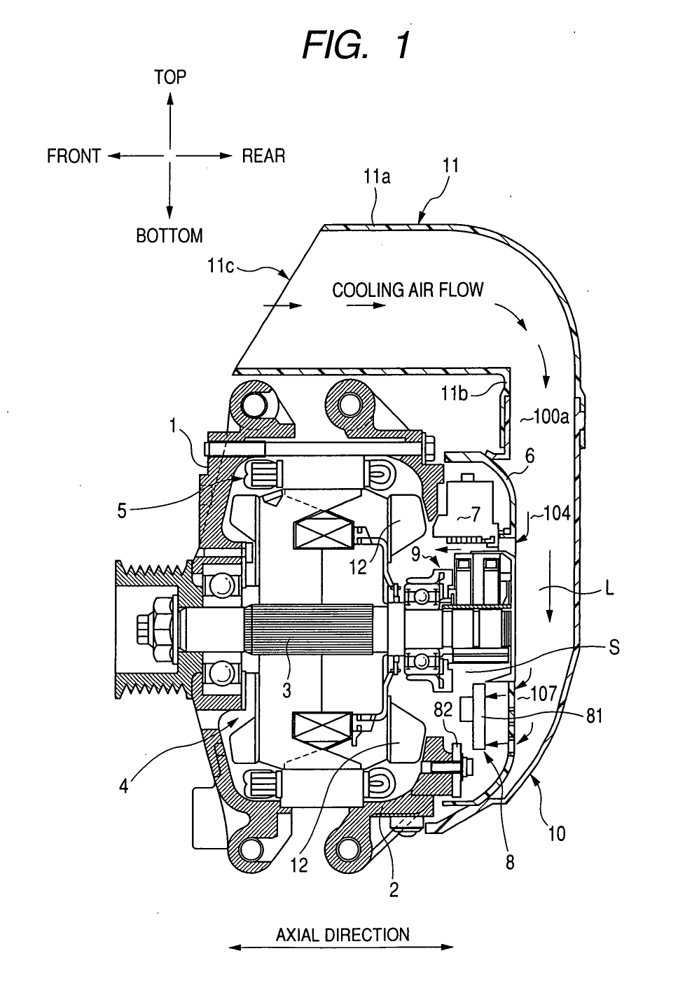

A description will be given of an improved mechanism of a cooling air flow passage for a vehicular alternator according to a first embodiment of the present invention with reference to FIG. 1 to FIG. 4.

FIG. 1 is a schematic cross sectional view of a vehicular alternator with a cooling air flow passage in an axial direction thereof according to a first embodiment of the present invention. The vehicular alternator is fixed to a side part of a vehicular engine (omitted from diagrams) vertically disposed in an engine room of a vehicle. The vehicular alternator is driven by the vehicle engine through a belt, that is, the rotary power generated by the vehicular engine is transmitted to the vehicular alternator through the belt. An exhaust gas passage system is placed close to the rear side of the vehicular alternator.

As shown in FIG. 1, the vehicular alternator has a frame made of metal. The frame is composed of a front frame 1 and a rear frame 2 which are forcedly fastened by through bolts. The front frame 1 and the rear frame 2 form a closed inner space shown in FIG. 1. The front frame 1 and the rear frame 2 rotatably support a rotary shaft 3 of the vehicular alternator through bearings. A Lundell type rotor 4 of the vehicular alternator is fixed to the rotary shaft 3. A stator 5 faces to an outer circumferential surface of the Lundell type rotor 4 and is disposed between the front frame 1 and the rear frame 2.

As shown in FIG. 1, a primary rear cover 6 has a shallow plate shape, is made of resin, and accommodates the outer-wall surface of the rear frame 2. The primary rear cover 6 is fastened to the rear frame 2.

An electrical component room S is formed between the outer-wall surface of the rear frame 2 and the primary rear cover 6. A regulator 7, a rectifier 8, and a field-coil power supply mechanism 9 are placed in the electrical component room S. As well known in this technical field, the rectifier 8 has a horseshoe shaped positive (+) fin 81 and a horseshoe shaped negative (−) fin 82 which are placed at a small interval around the rotary shaft 3 in its axial direction.

The field-coil power supply mechanism 9 has two pairs of a slip ring and a brush. The brush extends toward the top side of the rotary shaft 3. Because the configuration of each of the slip ring and the brush is widely well known in this technical field, the explanation of those components is omitted here. Because such a manner of arranging those electrical components at the rear side of the vehicular alternator is well known and disclosed in various related-art documents, the explanation for those electrical components is also omitted here.

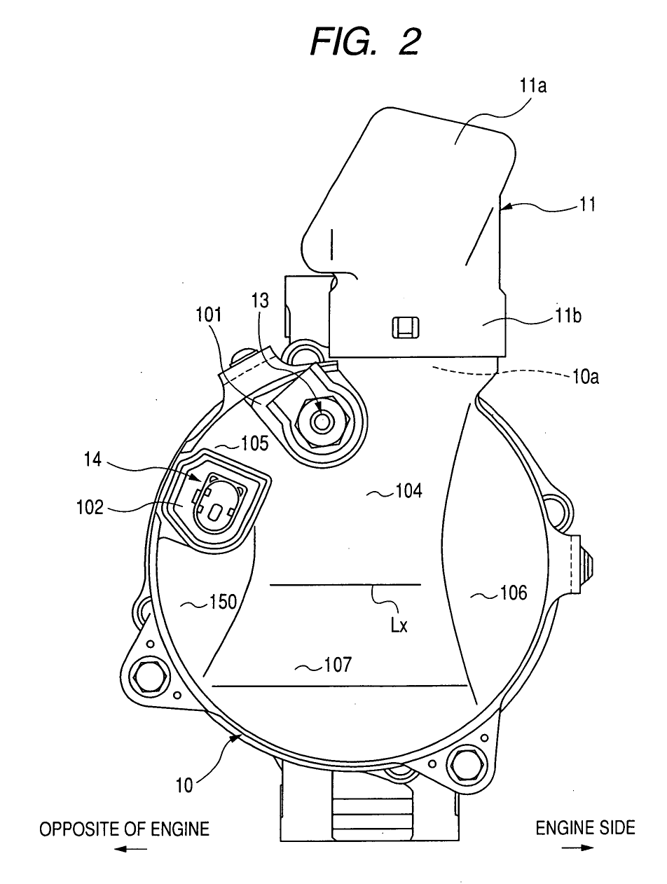

As shown in FIG. 1 and FIG. 2, a secondary rear cover 10 has a shallow plate shape and is made of resin. An inlet opening 10a is open at the top end in the circumferential wall part of the secondary rear cover 10. (see FIG. 2 which will be explained later)

As shown in FIG. 1, the secondary rear cover 10 accommodates the primary rear cover 6 and is fastened to the rear frame 2. A cooling air room L is formed between the primary rear cover 6 and the secondary rear cover 10 and the cooling air room L is positioned at the rear side of the electrical component room S in the vehicular alternator.

A suction duct 11 of a tube shape such as a rectangle tube shape and a cylindrical shape joins to the inlet opening 10a of the secondary rear cover 10. The suction duct 11 extends toward the front side of the axial direction of the vehicular alternator. The suction duct 11 is composed of an axial-direction duct 11a and a radial-direction duct 11b. The axial-direction duct 11a extends toward the front part of the vehicular alternator in the axial-direction thereof. The radial-direction duct 11b shortly extends toward the bottom side of the vehicular alternator, and joins to the inlet opening 10a of the secondary rear cover 10. The front end opening of the axial-direction duct 11a acts as a suction opening 11c through which a cooling air is introduced, namely sucked in the suction duct 11 in the cooling air flow passage.

A description will now be given of the basic flow of the cooling air in the cooling air flow passage for the vehicular alternator having the above configuration according to the first embodiment.

A centrifuge fan 12 fixed to the rear end surface of the Lundell type rotor 4 generates the flow of cooling air in the centrifuge direction by rotating the Lundell type rotor 4. The cooling air generated is sucked into the axial-direction duct 11a through the suction opening 11c. The cooling air flows toward the rear side of the axial-direction duct 11a in the axial direction. The boundary part between the axial-direction duct 11a and the radial-direction duct 11b changes the cooling air flow to the cooling air room L as the inside of the cooling air flow passage along the radial direction of the vehicular alternator. That is, the cooling air flow is supplied along the centripetal direction into the cooling air room L from the inlet opening 10a of the secondary rear cover 10.

The cooling air supplied into the cooling air room L blows the electrical component room S through the holes formed in the primary rear cover 6. The cooling air flow is then sucked into the inside of the centrifugal fan in its radial direction through frame suction-holes 2a which are open at the end wall part of the rear frame 2.

As described above, the cooling air flow passage for the vehicular alternator having the improved mechanism described above according to the first embodiment of the present invention is not equipped with any electrical fan which has been used in the related art technique JP H5-219685 prescribed.

A description will now be given of the configuration of the secondary rear cover 10 with reference to FIG. 2 to FIG. 4.

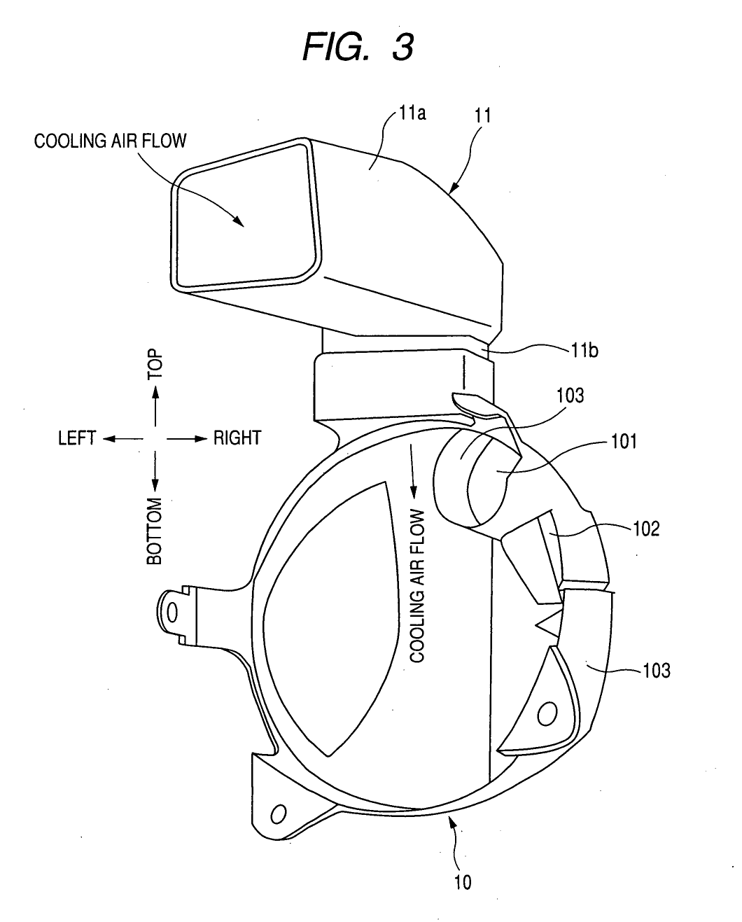

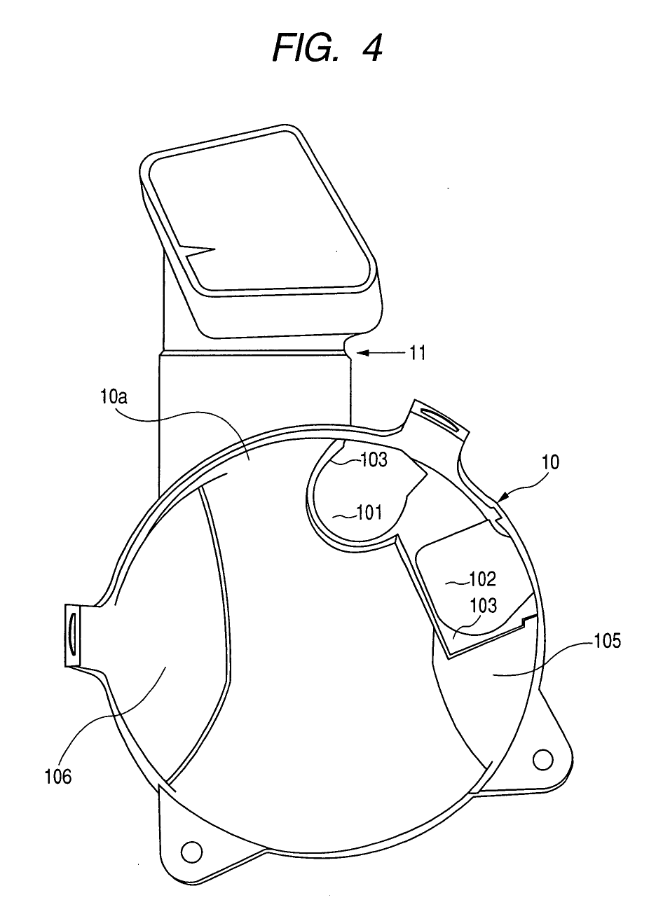

FIG. 2 is an elevation view of the cooling air flow passage for the vehicular alternator observed from the rear side of the vehicular alternator according to the first embodiment shown in FIG. 1. FIG. 3 is a perspective view of the secondary rear cover 10 and the suction duct 11 in the cooling air passage for the vehicular alternator according to the first embodiment shown in FIG. 1. FIG. 4 is a perspective view of the secondary rear cover 10 observed from its front part toward its rear side in the axial direction of the vehicular alternator according to the first embodiment shown in FIG. 1.

In FIG. 2, an output terminal 13 of a rod shape extends from the rectifier 8 toward the rear side in the axial direction of the vehicular alternator. A connector part 14 projects from of the regulator 7 toward the rear side in the axial direction.

A front end terminal of a cable (not shown) is electrically connected to the output terminal 13, and an outside connector (not shown) is electrically connected to the connector part 14. The outside connector is electrically connected to a vehicular electric control unit (ECU, not shown).

In the first embodiment, a horizontal distance between the output terminal 13 and the connector part 14 and the engine body (not shown) is larger than a horizontal distance between the suction duct 11 and the vehicular engine (not shown). In other words, as shown in FIG. 2, the output terminal 13 and the connector part 14 are disposed at the side which is the opposite of the vehicular engine observed from the center of the axis of the vehicular alternator. However, because this arrangement of the output terminal 13 and the connector part 14 is not the important matter of the present invention, it is possible to arrange the output terminal 13 and the connector part 14 at a different position.

The secondary rear cover 10 has an output terminal window 101 and a regulator connector window 102. The output terminal window 101 and the regulator connector window 102 are open in the axial direction of the vehicular alternator.

The output terminal window 101 and the regulator connector window 102 are formed by dividing the cooling air room L in the secondary rear cover 10. In the output terminal window 101, the output terminal 13 of the rectifier 8 projects towards the axial direction of the vehicular alternator. In the regulator connector window 102, the connector part 14 of the regulator 7 projects towards the axial direction of the vehicular alternator.

The output terminal window 101 and the regulator connector window 102 are separated from the cooling air room L in the secondary rear cover 10 by a partition wall 103 which is integrally formed in a single body with the secondary rear cover 10. The horseshoe shaped positive (+) fin 81 and the horseshoe shaped negative (−) fin 82 are not disposed in the output terminal window 101 and the regulator connector window 102 separated by the partition wall 103, which are similar to the configuration of the related art technique JP H5-219685 prescribed.

As shown in FIG. 3, the partition wall 103 stands from the end wall part of the secondary rear cover 10 toward the front side of the axial direction of the vehicular alternator, namely, towards the pulley side of the vehicular alternator.

A height of the partition wall 103 is approximately equal to a width of the inlet opening 10a in the axial direction of the vehicular alternator. The partition wall 103 is positioned at the right side of the inlet opening 10a which is positioned approximately at the top end of the circumferential wall part of the secondary rear cover 10. In the configuration of the first embodiment, although the output terminal window 101 is positioned close to the inlet opening 10a when compared with the position of the regulator connector window 102, it is possible to exchange those positions to each other.

In the air flow passage for the vehicular alternator having the configuration described above, the partition wall 103 can obstruct the diffusion of the cooling air flow toward its side direction and guides the cooling air flow toward the approximate bottom direction in the cooling air room L from the inlet opening 10a of the secondary rear cover 10. In other words, the partition wall 103 acts as a guide plate capable of preventing the diffusion of the cooling air flow toward the side direction (toward the right direction in FIG. 3), where the cooling air flow blows from the inlet opening 10a into the cooling air room L of a wide width in a right-left direction.

It is known to increase the fluid resistance by the generation of vortex and the like when the direction of the fluid flow is changed at an acute or shape angle or when the sectional area of a fluid flow passage is rapidly increased.

In the configuration of the cooling air flow passage of the improved mechanism according to the first embodiment, the partition wall 103 can prevent the rapid increase of the sectional area of the cooling air flow passage from the inlet opening 10a to the cooling air room L of a wide width in the right-left direction. It is thereby possible to supply the cooling air flow to the bottom side of the rotary shaft by a relatively low driving power of the cooling fan without decreasing the speed of the cooling air flow caused by rapidly increasing the fluid resistance in the cooling air flow passage.

Next, a description will now be given of a detailed explanation of an axial depth or a position of each part in the end wall part of an approximate circular shape in the secondary rear cover 10 in the axial direction with reference to FIG. 2.

The end wall part of the secondary rear cover 10 is divided into an inlet opening proximity part 104 from the inlet opening 10a to a center part in the radial direction, right and parts 105 and 106 at right and left of the secondary rear cover 10, and an end part 107 of the cooling air flow passage from the inlet opening proximity part 104 to the bottom end part.

The inlet opening proximity part 104 is formed in a flat shape in the radial direction and positioned at the rearmost side in the axial direction of the vehicular alternator. The side parts 105 and 106 are formed at the both sides of the secondary rear cover 10 so that the side parts 105 and 106 are separated at right and left sides from the inlet opening proximity part 104 and are gradually shifted to the front part in the axial direction while approaching the boundary part of the end wall part of the secondary rear cover 10.

A distal end part 107 of the cooling air flow passage is a part from the line “Lx” shown in FIG. 2 to the bottom end of the end wall part of the secondary rear cover 10. The distal end part 107 is so formed that the distal end part 107 is separated at the inlet opening proximity part 104 and is gradually shifted to the front part in the axial direction of the vehicular alternator while approaching the boundary part of the end wall part of the secondary rear cover 10.

The side parts 105 and 106 of the secondary rear cover 10 obliquely formed described above can suppress the diffusion of the cooling air flow, blowing from the inlet opening 10a, toward both the right and left directions. It is thereby possible to increase the supplying volume of the cooling air at the distal end part in the cooling air room L which is the most far position form the inlet opening 10a.

Because the side parts 105 and 106 are obliquely formed so that the cooling air room L is drawn in the axial direction of the vehicular alternator, it is possible to supply a necessary volume of the cooling air by changing a part of the cooling air flow from the inlet opening proximity part 104. The side parts 105 and 106 obliquely formed described above can smoothly change the cooling air flow toward the front side in the axial direction of the vehicular alternator.

In addition, the distal end part 107 of the cooling air flow passage is obliquely formed in the bottom half part of the cooling air room L along the axial direction of the vehicular alternator. The cooling air flow blowing toward the bottom direction of the distal end part 107 of the cooling air flow passage is smoothly changed to the front side in the axial direction.

Still further, the first embodiment of the present invention adopts the improved construction of the cooling air flow passage in which the cooling air flow blowing down from the suction duct 11 of a character “L” shape is supplied to the cooling air room L which is positioned at the rear side of the electrical component room S, and the cooling air is then dispersed from the cooling air room L to the electrical component room S positioned in the front of the cooling air room L. This configuration can efficiently supply the cooling air flow to electro-mechanical components disposed at the downstream side of the electrical components in the electrical component room S because the cooling air does not blow the electrical components.

Various types of holes and openings are formed in the primary rear cover 6 in order to efficiently cool the electrical components in the electrical component room S such as semiconductor elements in the regulator 7 and the rectifier 8. The height of the suction opening 11c in the suction duct 11 is approximately twice of the width of the inlet opening 10a of the secondary rear cover 10 in the axial direction of the vehicular alternator. This configuration of the suction opening 11c can reduce the fluid resistance by reducing the blowing speed of the cooling air flow at the suction opening 11c and the axial-direction duct 11a of the suction duct 11. On the contrary, there is a limitation of increasing the width of the inlet opening 10a in the axial direction because of increasing the total size of the vehicular alternator.

According to the first embodiment of the present invention, because the vehicular alternator adopts the rear side cooling air suction manner using the suction duct of a character “L” shape, it is possible to efficiently shield the vehicular alternator from the air flow supplied from the exhaust gas passage of the vehicular engine. Still further, it is possible to efficiently use a cooling air flow caused by moving the vehicle when the concept of the first embodiment of the present invention described above is adapted to the vehicle equipped with a longitudinal engine vertically-disposed.

### Second Embodiment

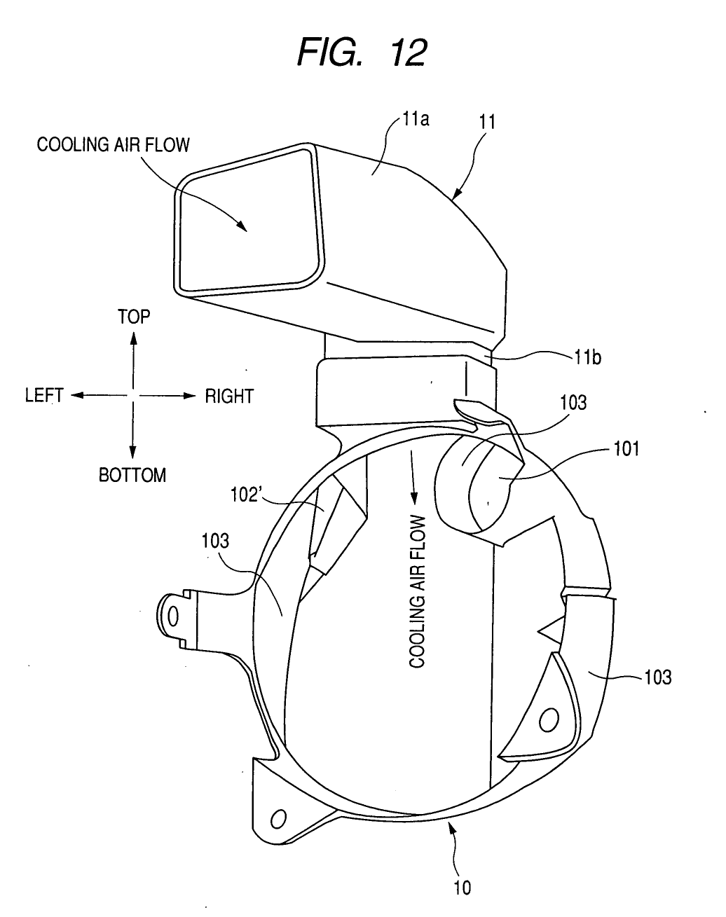

A description will be given of the cooling air flow passage of an improved mechanism for the vehicular alternator according to the second embodiment of the present invention with reference to FIG. 12.

FIG. 12 is a perspective view of the second rear cover 10 and the suction duct 11 in the cooling air flow passage for the vehicular alternator according to the second embodiment. The same components between the first to second embodiments will be referred to as the same reference numbers and the explanation for the same components is omitted here for brevity.

In the mechanism of the cooling air flow passage according to the second embodiment, the output terminal window 101 and a regulator connector window 102′ are disposed at both sides of the cooling air flow passage immediately below the inlet opening 10a of the secondary rear cover 10. This configuration of the cooling air flow passage guides the cooling air flow blowing from the inlet opening 10a toward the bottom side by the partition walls 103 formed at both sides of the secondary rear cover 10. It is thereby possible to efficiently prevent the increase of the fluid resistance of the cooling air flow passage.

### Third Embodiment

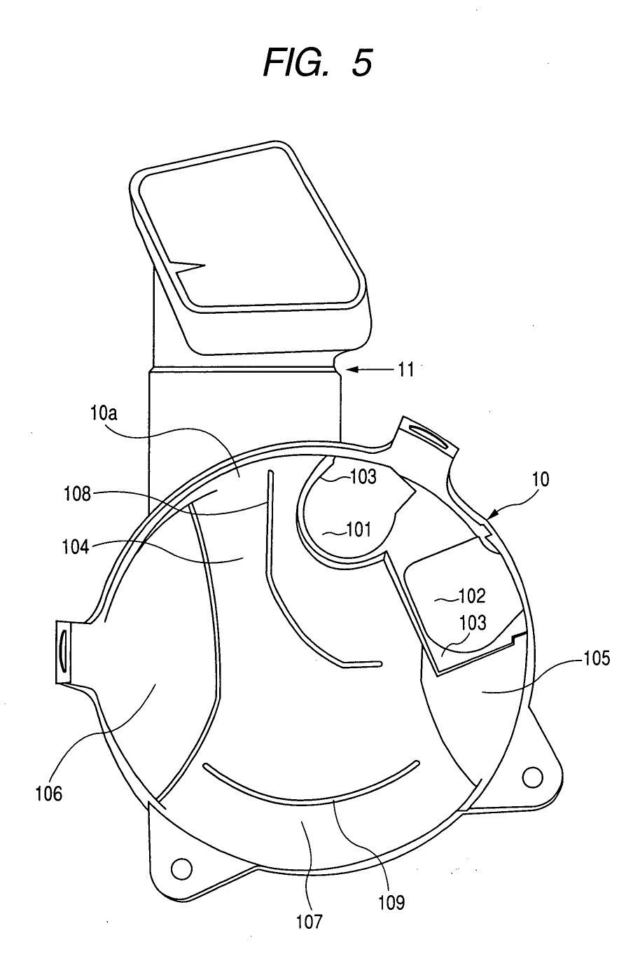

A description will be given of an improved mechanism of the cooling air flow passage for the vehicular alternator according to the third embodiment of the present invention with reference to FIG. 5.

FIG. 5 is a perspective view of the improved mechanism of the cooling air flow passage for the vehicular alternator according to the third embodiment, observed from a front part of the vehicular alternator toward a rear side in its axial direction of the vehicular alternator. The same components between the first to third embodiments will be referred to as the same reference numbers and the explanation for the same components is omitted here for brevity.

The cooling air flow passage for the vehicular alternator according to the third embodiment shown in FIG. 5 has projection parts 108 and 109 of a curved-plate shape (corresponding to “guide plates” defined in claims) formed on the inner surface of the end wall part of the secondary rear cover 10.

At first, the configuration and capability of the projection parts 108 and 109 will be explained. The top end of the projection part 108 is disposed immediately below the inlet opening 10a, and the distal end thereof is near the regulator connector window 102. The projection part 108 is disposed in the inlet opening proximity part 104 in the cooling air room L, and is gradually curved from its top end part in the direction of the regulator connector window 102. In the configuration of the second embodiment, the regulator 7 is disposed in the electrical component room S in front of and adjacent to the regulator connector window 102. Such a configuration of the projection part 108 changes the direction of a part of the cooling air flow blowing from the inlet opening 10a toward the front part in the axial direction of the regulator connector window 102, and enables the cooling air to efficiently flow into the gap between the regulator connector window 102 and the regulator 7 disposed in front of the regulator connector window 102 in order to efficiently cool the semiconductor ICs placed in the regulator 7.

The height of the projection part 108 depends on the volume of the cooling air flow to be guided into the regulator connector window 102.

Next, a description will now be given of the configuration and capability of the projection part 109. As shown in FIG. 5, the projection part 109 is curved in circular shape in the distal end part 107 of the cooling air flow passage from the axial core toward equal distances in both the right direction and the left direction.

Both the end parts of the projection part 109 reach approximately to the right end of and the left end of the distal end part 107 of the cooling air flow passage. The presence of the projection part 109 can efficiently change the cooling air, which is flowing from the inlet opening proximity part 104 to the distal end part 107 of the cooling air flow passage, at the position of the projection part 109 toward the front part of the axis of the regulator connector window 102. It is thereby possible to efficiently cool the rectifying diodes in the rectifier 8 disposed near the projection part 109.

### Fourth Embodiment

A description will be given of an improved mechanism of the cooling air flow passage for the vehicular alternator according to the fourth embodiment of the present invention.

The feature of the cooling air flow passage for the vehicular alternator according to the fourth embodiment has not the primary rear cover 6 which is used in the configuration of the cooling air flow passage of the first embodiment. The cooling air flow passage according to the fourth embodiment is thereby formed with a simple configuration and can reduce the total number of components forming the cooling air flow passage.

### Fifth Embodiment

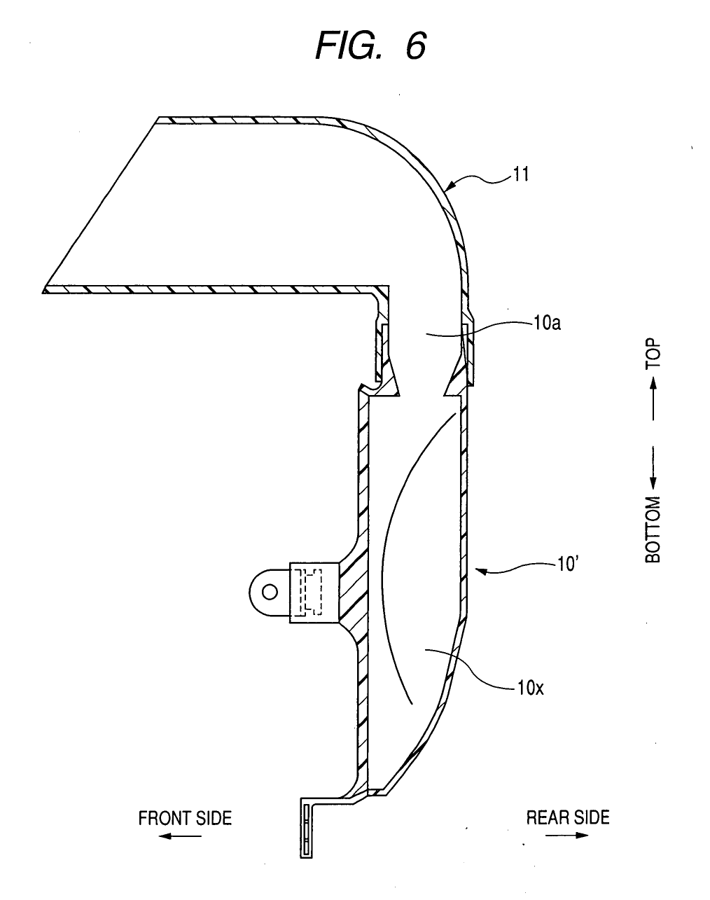

A description will be given of an improved mechanism of the cooling air flow passage for the vehicular alternator according to the fifth embodiment of the present invention with reference to FIG. 6.

FIG. 6 is a cross-sectional view of the rear cover 10′ and the suction duct 11 for the vehicular alternator according to the fifth embodiment of the present invention. The same components between the first to fifth embodiments will be referred to as the same reference numbers and the explanation for the same components is omitted here for brevity.

The cooling air flow passage for the vehicular alternator according to the fifth embodiment has the rear cover 10′ which is composed of the primary rear cover 6′ and the secondary rear cover 10′ in a single body. The use of the rear cover 10′ can increase its rigidity.

### Sixth Embodiment

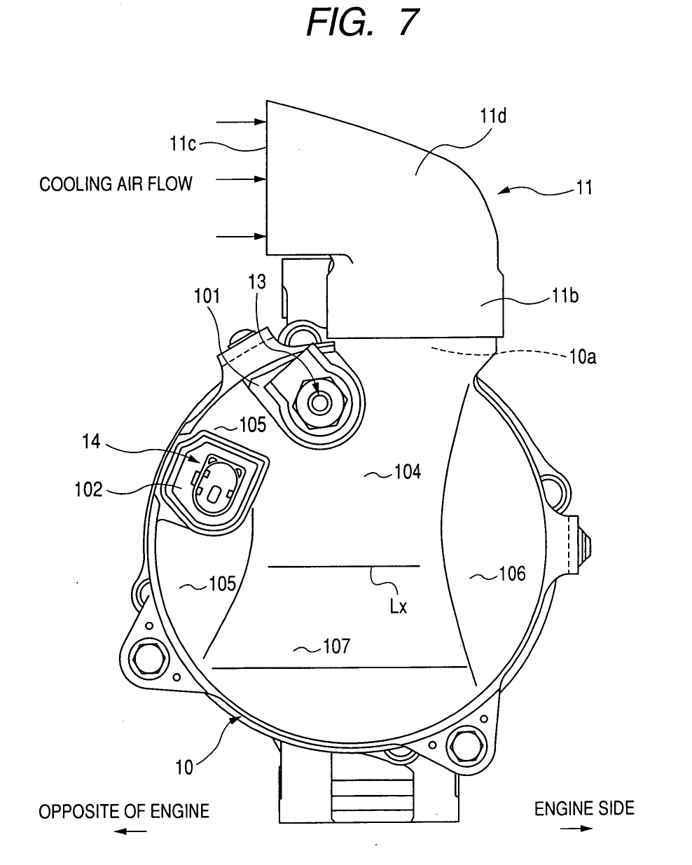

A description will be given of an improved mechanism of the cooling air flow passage for the vehicular alternator according to a sixth embodiment of the present invention with reference to FIG. 7.

FIG. 7 is an elevation view of the vehicular alternator, observed from a rear side thereof, according to the sixth embodiment. The same components between the first to sixth embodiments will be referred to as the same reference numbers and the explanation for the same components is omitted here for brevity.

The configuration of the cooling air flow passage of the sixth embodiment has a tangential direction duct 11d which extends toward the direction of a tangential line, instead of the axial-direction duct 11a disclosed in the first embodiment shown in FIG. 2. Because the vehicular engine (not shown) is disposed in lateral direction in an engine room (not shown), the suction opening 11c of the tangential-direction duct 11d is open toward the front part of the vehicle.

It is thereby possible to efficiently suck the cooling air flow, which is not very much heated by the vehicular engine (not shown), into the secondary rear cover 10. This configuration of the cooling air flow passage of the sixth embodiment efficiently utilizes the cooling air flow generated during the travel of the vehicle even if the vehicular engine is disposed in a lateral direction.

### Seventh Embodiment

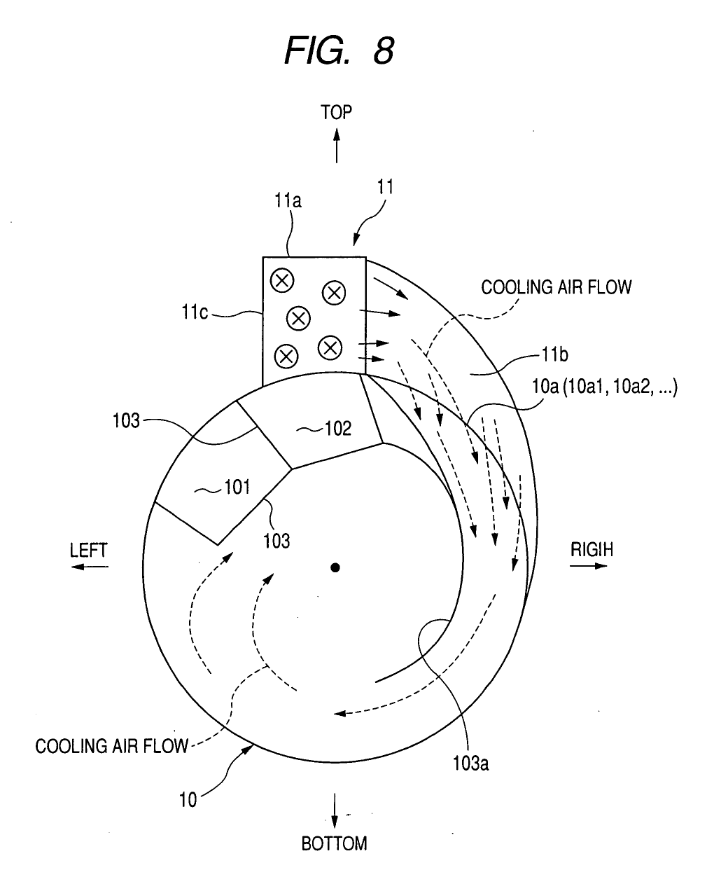

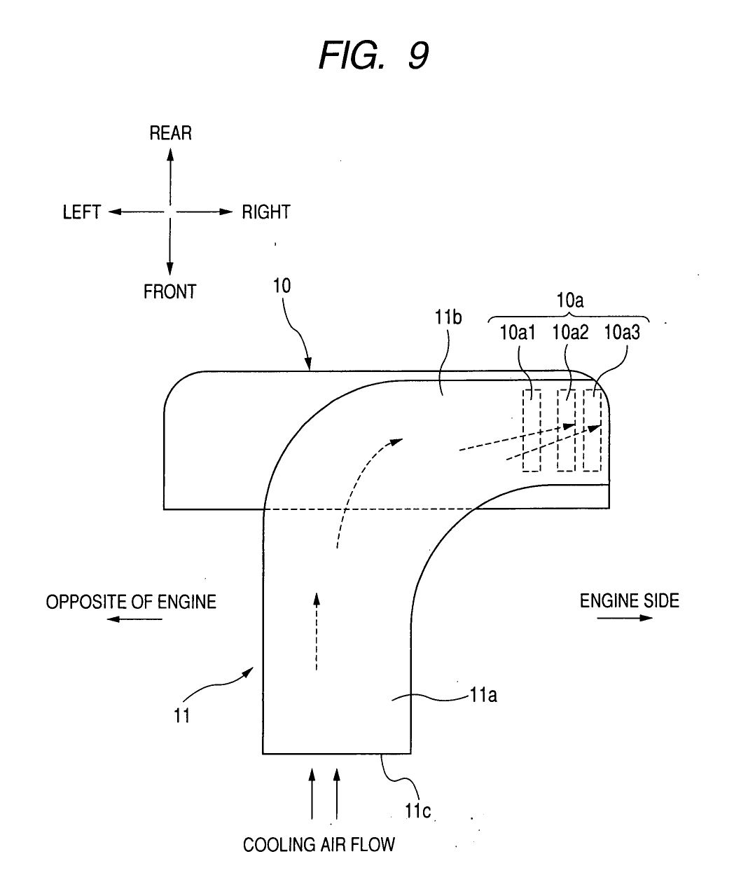

A description will be given of an improved mechanism of the cooling air flow passage for the vehicular alternator according to a seventh embodiment of the present invention with reference to FIG. 8 and FIG. 9.

FIG. 8 is a schematic elevation view of the second rear cover and the suction duct forming the cooling air flow passage for the vehicular alternator according to the seventh embodiment, observed from the front side toward the rear side of the vehicular alternator. FIG. 9 is an elevation view of the second rear cover and the suction duct forming the cooling air flow passage for the vehicular alternator according to the seventh embodiment. In particular, the output terminal window 101 is omitted from FIG. 9. The same components between the first to seventh embodiments will be referred to as the same reference numbers and the explanation for the same components is omitted here for brevity.

In the configuration of the cooling air flow passage for the vehicular alternator according to the seventh embodiment, the output terminal window 101 is open at the circumferential wall part and the end wall part, and the regulator connector window 102 is open at the rear side in the axial direction. This configuration of those components enables that the suction duct 11 is placed close to the regulator connector window 102.

In the configuration of the seventh embodiment, the vehicular alternator is mounted on the vehicular engine which is a longitudinal engine vertically disposed in an engine room (not shown), and the suction opening 11c in the suction duct 11 is open toward a pulley side. The suction duct 11 is composed of the axial-direction duct 11a and the radial-direction duct 11b. The axial-direction duct 11a extends toward the axial direction of the vehicular alternator. The radial direction duct 11b extends toward the rear side in the axial direction of the vehicular alternator and is continuously curved toward the right direction and further curved toward the inside in the radial direction, and finally extends toward the direction of an approximate tangential-line on the outer circumference of the circumferential wall part of the secondary rear cover 10.

The inlet opening 10a is composed of a plurality of inlet opening parts 10a1, 10a2, 10a3, . . . which are formed on the circumferential wall part of the secondary rear cover 10. The plural inlet openings 10a1, 10a2, 10a3, . . . are faced to the outlet of the radial-direction duct 11b. However, because the cooling air flows slantingly through the plural inlet opening part 10a1, 10a2, 10a3, . . . at an angle with respect to the plural inlet opening parts 10a1, 10a2, 10a3, . . . , the total sectional area of the plural inlet opening parts 10a1, 10a2, 10a3, . . . which are vertically faced to the cooling air flow becomes smaller than that of the suction opening 11c of the axial-direction duct 11a.

A guide wall 103a is vertically disposed in spiral shape from the inner end surface of the secondary rear cover 10 and spirally introduces the cooling air flow supplied from the inlet opening 10a (which is composed of the opening parts 10a1, 10a2, 10a3, . . . ) in the radial direction of the vehicular alternator. The guide wall 103a, the secondary rear cover 10, and the partition wall 103 are integrated and formed in one body. Because the suction duct 11 and the secondary rear cover 10 according to the seventh embodiment has a smooth curved shape, no rapidly curved part, and no rapidly-changed sectional area of the cooling air flow passage in them, it is possible to reduce the fluid resistance of the cooling air flow passage, and further to use the wind generated while the vehicle is traveling. Still further, it is possible to efficiently isolate the cooling air flow from the thermal energy of the vehicular engine and the like.

### Eighth Embodiment

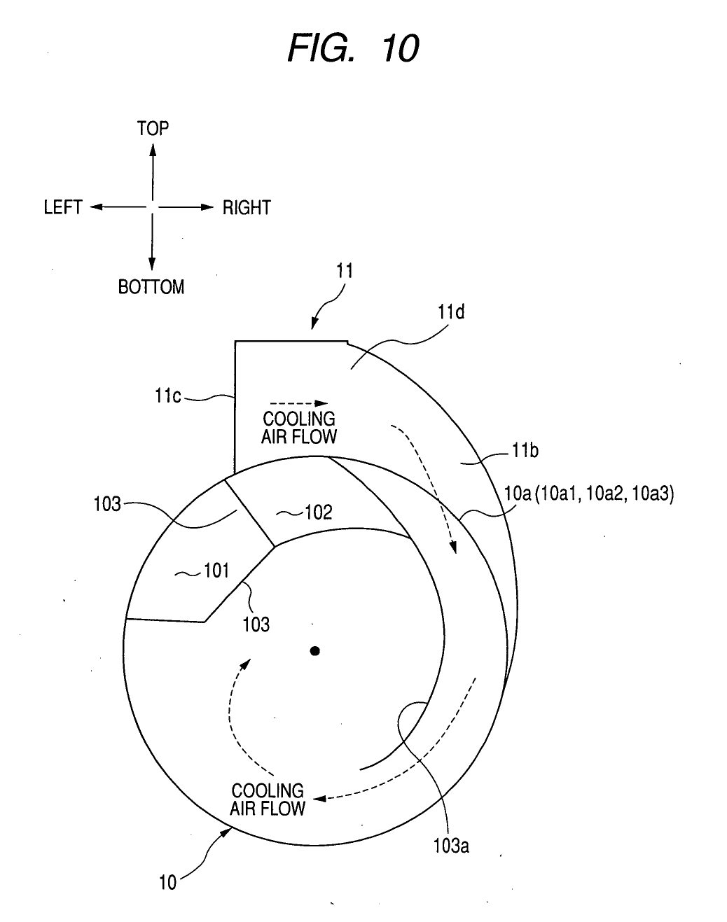

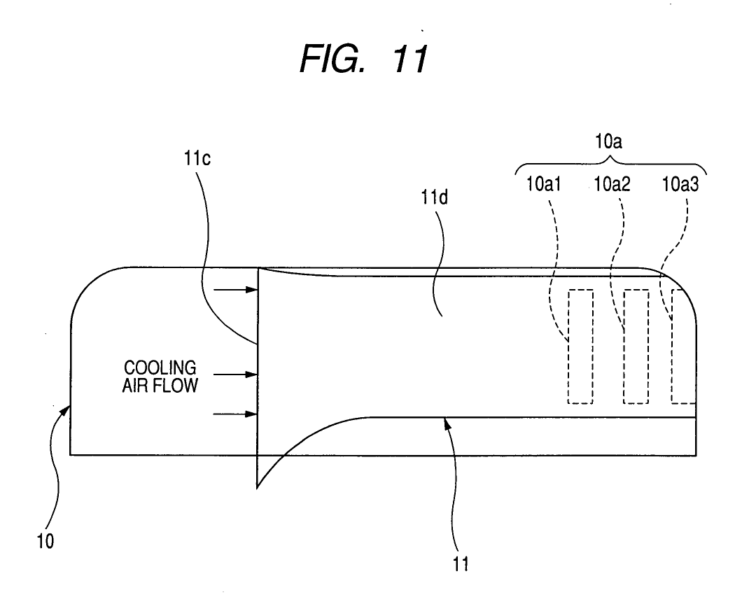

A description will be given of an improved mechanism of the cooling air flow passage for the vehicular alternator according to an eighth embodiment of the present invention with reference to FIG. 10 and FIG. 11.

FIG. 10 is a schematic elevation view of the second rear cover 10 and the suction duct 11 in the cooling air flow passage for the vehicular alternator according to the eighth embodiment, observed from a front part of the vehicular alternator toward a rear side in the axial direction of the vehicular alternator. FIG. 11 is an elevation view of the second rear cover and the suction duct in the cooling air flow passage for the vehicular alternator according to the eighth embodiment. The components of same capabilities in the first embodiment to the eighth embodiment will be referred to as the same reference numbers and the explanation for the same components is omitted here for brevity. In particular, the output terminal window 101 disposed at the circumferential wall part in the secondary rear cover 10 is omitted from FIG. 11.

In the configuration of the eighth embodiment, the output terminal window 101 is open at the circumferential wall part and the end wall part, and on the other hand, the suction duct 11 is disposed adjacent to the regulator connector window 102 because the regulator connector window 102 is open only at the rear side in the axial direction.

In the eighth embodiment, the vehicular alternator having the cooling air flow passage described above is mounted on a vehicular engine which is a transverse engine laterally disposed, and the suction opening 11c of the suction duct 11 is open toward the opposite of the vehicular engine in the lateral direction of the vehicle. The suction duct 11 has the tangential direction duct 11d which extends toward the direction of a tangential line of the secondary rear cover 10. The outlet of the suction duct 11 is joined to the inlet opening 10a composed of a plurality of inlet opening parts 10a1, 10a2, 10a3, . . . which are open in the circumferential wall part of the secondary rear cover 10. The circumferential wall part of the secondary rear cover 10 has the plural inlet opening parts 10a1, 10a2, 10a3, . . . facing the outlet of the radial-direction duct part 11b. Because the cooling air slantingly passes through the plural inlet opening parts 10a1, 10a2, 10a3, . . . at an angle with respect to the plural inlet opening parts 10a1, 10a2, 10a3, . . . , the total sectional area of the flow passage of the plural inlet opening parts 10a1, 10a2, 10a3, . . . which are vertically faced to the cooling air flow becomes smaller than that of the suction opening 11c of the axial-direction duct 11a.

The guide wall 103a is vertically disposed in spiral shape from the inner end surface of the secondary rear cover 10 and spirally introduces the cooling air flow supplied from the inlet opening parts 10a1, 10a2, 10a3, . . . in the radial direction of the vehicular alternator. The guide wall 103a, the secondary rear cover 10, and the partition wall 103 are assembled and formed in one body. The cooling air flow passage in the suction duct 11 and the secondary rear cover 10 according to the seventh embodiment has a smooth curved shape, no rapidly curved part, and no rapidly-changed sectional area of the cooling air flow passage. This configuration can reduce the fluid resistance of the cooling air flow passage, and further uses the wind generated while the vehicle is traveling. Still further, it is possible to efficiently isolate the cooling air flow from the thermal energy of the vehicular engine and the like.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A cooling air flow passage for a vehicular alternator comprising:
a suction duct of a tube shape extending from its suction opening through which external cooling air is sucked; and
a rear cover of a shallow plate shape, having an inlet opening formed at a top of a circumferential wall of the rear cover and introducing the cooling air supplied from the suction duct, accommodating a rear end surface of an alternator housing which accommodates electrical components of the vehicular alternator at least a regulator and a rectifier, and a sectional area of the inlet opening of the rear cover being smaller than a sectional area of the suction opening of the suction duct.

2. The cooling air flow passage for the vehicular alternator according to claim 1, wherein the rear cover comprises a partition wall for a connector part surrounding external electrical terminals for the electrical components, and
the partition wall for the connector part is vertically disposed from an end wall part of the rear cover toward the inside direction of the rear cover in an axial direction of the vehicular alternator along a side surface of the cooling air flow supplied from the inlet opening into the inside of the rear cover in an approximate radial direction of the vehicular alternator.

3. The cooling air flow passage for the vehicular alternator according to claim 1, wherein the end wall part of the rear cover is positioned at a side of the cooling air flow passage supplied from the inlet opening to the inside of the rear cover in the approximate radial direction of the vehicular alternator, and the end wall part of the rear cover has a concave shape toward the front side of the axial direction of the vehicular alternator when compared with the shape of a part other than the end wall part of the rear cover.

4. The cooling air flow passage for the vehicular alternator according to claim 1, wherein the electrical components are disposed in front of the inlet opening of the rear cover in the axial direction of the vehicular alternator, and
the inside end wall surface of the rear cover comprises a guide plate projecting toward the front side of the axial direction of the vehicular alternator capable of changing the cooling air flow supplied from the inlet opening to the inside direction of the rear cover along the radial direction of the vehicular alternator toward one of the front of the axial direction of the vehicular alternator and a predetermined direction in the radial direction of the vehicular alternator.

5. The cooling air flow passage for the vehicular alternator according to claim 4, wherein the guide plate has a shape which curves from a part close to the inlet opening to a part close to the regulator at a lateral side of the rear cover.

6. The cooling air flow passage for the vehicular alternator according to claim 4, wherein the guide plate is positioned close to rectifying elements forming the rectifier and has a shape of changing the cooling air flow supplied from the inlet opening into the inside of the rear cover toward a front part in the axial direction of the vehicular alternator.

7. The cooling air flow passage for the vehicular alternator according to claim 1, wherein the suction duct has a character “L” shape which extends from the inlet opening, through which the external cooling air is sucked, toward the rear side in the approximate axial direction of the vehicular alternator and curves to the inlet opening of the rear cover along the approximate radial inside direction of the vehicular alternator.

8. The cooling air flow passage for the vehicular alternator according to claim 1, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

9. The cooling air flow passage for the vehicular alternator according to claim 2, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

10. The cooling air flow passage for the vehicular alternator according to claim 3, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

11. The cooling air flow passage for the vehicular alternator according to claim 4, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

12. The cooling air flow passage for the vehicular alternator according to claim 5, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

13. The cooling air flow passage for the vehicular alternator according to claim 6, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

14. The cooling air flow passage for the vehicular alternator according to claim 7, wherein the suction duct has a character “L” shape which extends from the inlet opening, through which the external cooling air is sucked, toward an engine side along a direction of an approximately tangential line of the rear cover, and the suction duct curves to the inlet opening of the rear cover along the approximate radial inside direction of the vehicular alternator.

15. The cooling air flow passage for the vehicular alternator according to claim 1, wherein the inlet opening has a shape capable of sucking the cooling air flow from the circumferential wall part of the rear cover into the inside of the rear cover along an approximately tangential direction of the rear cover, and
the inner end surface of the rear cover comprises a guide wall by which the cooling air flow supplied through the inlet opening is spirally introduced into the inner radial direction of the vehicular alternator.

16. The cooling air flow passage for the vehicular alternator according to claim 15, wherein the inlet opening is composed of a plurality of inlet opening parts.

17. The cooling air flow passage for the vehicular alternator according to claim 15, wherein a regulator window through which a regulator connector of the regulator is electrically connected to outer cables is formed adjacent to the suction duct.
